(19) United States
(12) Patent Application Publication
(10) Pub. No.: US 2012/0033533 A1
(43) Pub. Date: Feb. 9, 2012

(54) ELECTRONIC DEVICE WITH ALARM MODE AND ALARM METHOD THEREOF

(75) Inventors: XIAO-GUANG LI, Shenzhen City (CN); CHIANG-KUO TANG, Tu-Cheng (TW); KUAN-HONG HSIEH, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD ., Shenzhen city (CN)

(21) Appl. No.: 13/081,447

(22) Filed: Apr. 6, 2011

(30) Foreign Application Priority Data
Aug. 4, 2010 (CN) 201010245084.7

(51) Int. Cl. G04G 13/02

(52) U.S. Cl. 368/251

(57) ABSTRACT

An electronic device includes an input unit to generate input signals according to a users input. A storage unit to store audio files, an alarm speaker unit to sound the alarm audio files and execute the alarm commands. In addition, a processing unit to sound the alarm after a system time reaches a preset time period. Moreover, analyses operation type according to the input signals to control the speaker unit to resound the alarm or not sound the alarm after a time period according to the operation type. An alarm method is also provided.

### BACKGROUND

1. Technical Field

The present disclosure relates to electronic devices and, particularly, to an electronic device with an alarm mode and an alarm method.

2. Description of the Related Art

Many electronic devices with alarm functions provide menu options for users to select the type of alarm, for example, repeated alarm, or non-repeated alarm. However, many alarms do not allow users to set the time interval for repeated alarms conveniently according to the needs of the users or based on different the situations.

### BRIEF DESCRIPTION OF THE DRAWINGS

The components of the drawings are not necessarily drawn to scale, the emphasis instead being placed upon clearly illustrating the principles of an electronic devices with alarm mode and a alarm method. Moreover, in the drawings, like reference numerals designate corresponding parts throughout multiple views.

FIG. 1 is a schematic view of an electronic device with alarm mode in accordance with an exemplary embodiment.

FIG. 2 is a block diagram of the electronic device of FIG. 1.

FIG. 3 is a flowchart of an alarm method applied in the electronic device of FIG. 1 in accordance with an exemplary embodiment.

### DETAILED DESCRIPTION

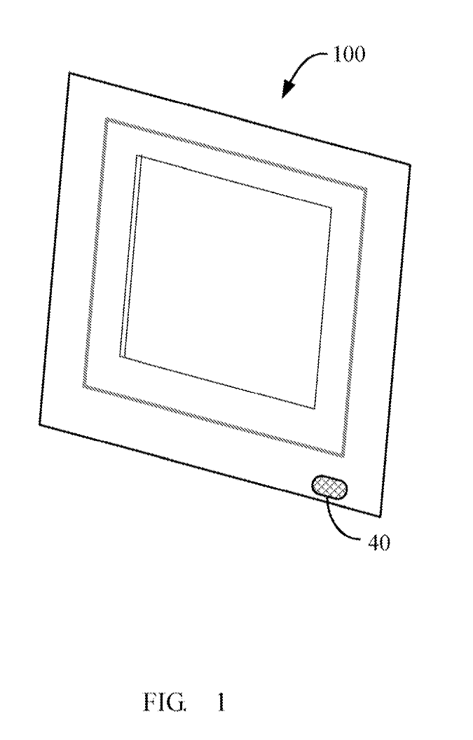

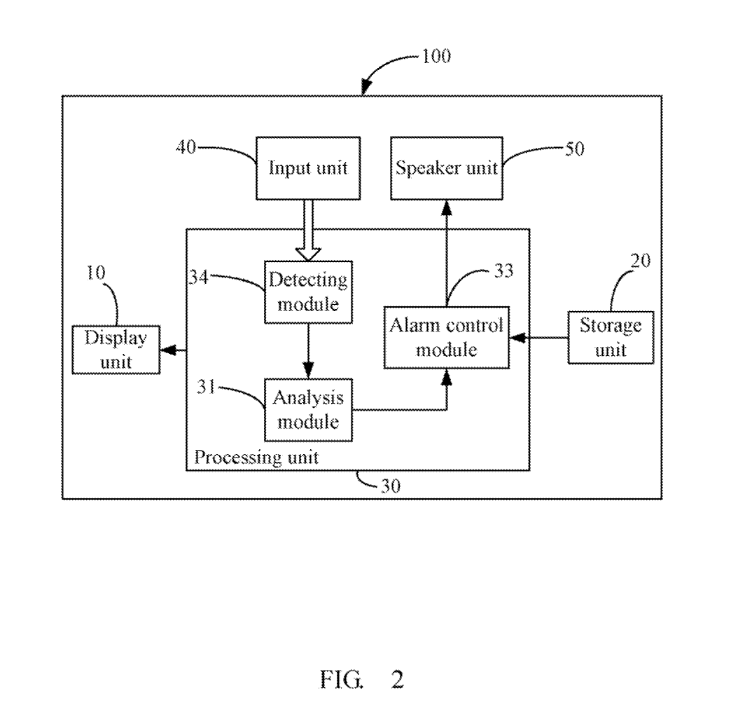

Referring to FIGS. 1 and 2, an electronic device 100 is shown, in the embodiment, the electronic device 100 is a digital photo frame. The electronic device 100 includes a display unit 10, a storage unit 20, a processing unit 30, an input unit 40 and a speaker unit 50. In this embodiment, the storage unit 20 stores a number of alarm audio files. When the system time reaches a preset alarm time, the processing unit 30 reads an alarm audio file from the storage unit 20, and controls the speaker unit 50 to sound the alarm audio file, i.e., sound the alarm. For example, the processing unit 30 randomly reads an alarm audio file or reads a particular alarm audio file. When the alarm audio file is sounding, the processing unit 30 responds to input signals generated by the input unit 40 according to the user operations, analyses the user's operation type according to the input signals and controls the speaker unit 50 to replay the alarm audio file (i.e., sound again) after a time period according to the operation type.

In the embodiment, the processing unit 30 includes an analysis module 31, a detecting module 34, and an alarm control module 33. The alarm control module 33 is configured to determine whether the system time reaches a preset alarm time, and controls the speaker unit 50 to sound an alarm if the system time reach a preset alarm time. The detecting module 34 detects the input signals during the sounding of the alarm, and transmits the input signals to the analysis module 31. The analysis module 31 determines the operation type according to the input signals. In the embodiment, there are a number of operation types and the alarm control module 33 executes different alarm commands according to different operation types. The alarm control module 33 controls the alarm speaker unit 50 to stop sounding the alarm, but to sound the alarm again after a first preset time period t1, for example, after five minutes, if the alarm control module 33 determines that the operation type is a first operation type. The alarm control module 33 controls the alarm speaker unit 50 to sound the alarm again after a second preset time period t2, such as after ten minutes, if the user operation type is a second operation type. The alarm control module 33 controls the alarm speaker unit 50 to stop sounding the alarm until it has been reset, if the user operation type is a third operation type.

The detecting module 34 detects the input signal generated by the input unit 50. The analysis module 31 determines that the operation type is the first operation if the input signal does not exist beyond a third preset time period T3. The analysis module 31 determines that the operation type is the second operation if the input signal exists beyond the third preset time period T3 but not beyond a fourth preset time period T4; the analysis module 31 determines that the operation type is the third operation if the input signal exists beyond the fourth preset time period T4. In another embodiment, the input unit 40 is a touch panel, and the analysis module 31 determines the user operation type according to the number of the input signals during a preset time period.

In this embodiment, the input unit 40 is a control button, the alarm is configured to wake users at a preset time. When the system time reaches the preset time, the alarm control module 33 controls the alarm speaker unit 50 to sound the alarm to wake the user. If the user still feels tired and needs to go back to sleep, he or she wants the electronic device 100 to sound the alarm again to wake them after a suitable time period, therefore, the user can operate the control button and command the electronic device 100 to sound the alarm again after the suitable time period. In response to the alarm, the user can operate the control button to interrupt the alarm and conveniently set the time period simultaneously. In the exemplary embodiment, the time period is proportional to the duration time of the operation applied to the control button. For example, if the duration time of the operation is 1 second, the time period is 5 minutes, if the duration time of the operation is 2 seconds, the time period is 10 minutes. In another exemplary embodiment, the time period is proportional to the number of operations applied to the control button in a preset time period. For example, only one operation means the user wants the electronic device 100 to sound the alarm 5 minutes later, two operations means the user wants the electronic device 100 to sound the alarm 10 minutes later. In still another exemplary embodiment, the time period is proportional to the pressure applied to the control button. In the above embodiments, if the duration time of an operation, or the number of operations, or the pressure of an operation goes beyond a threshold value, the alarm speaker unit 50 stops sounding the alarming until after it has been reset. For example, if the duration time of an operation lasts more than 2 s or the number of operations is greater than two, the alarm speaker unit 50 stops sounding the alarm until it has been reset.

The display unit 10 is also configured to display the operation type and the time period to sound the alarm corresponding to the operation type to provide convenience for user.

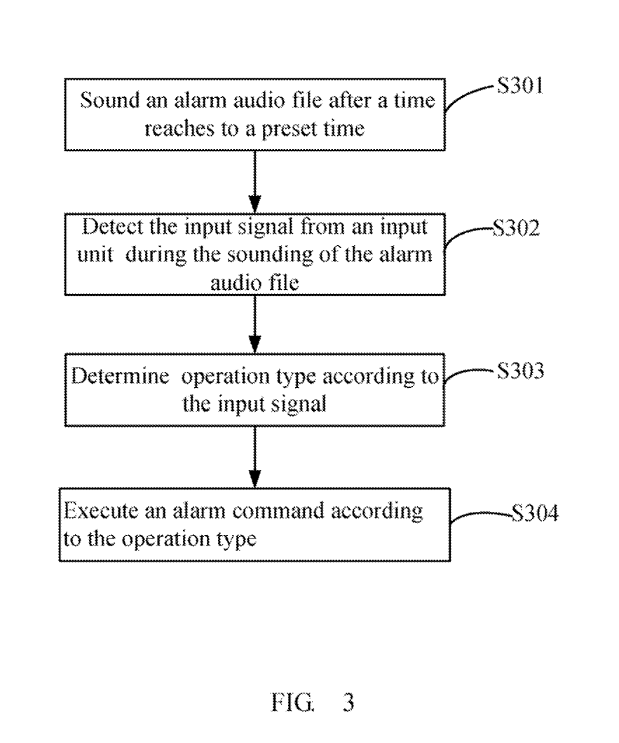

Referring to the FIG. 3, an alarm method is applied in the electronic device 100 in accordance with an exemplary embodiment.

In step S301, an alarm control module 33 controls an alarm speaker unit 50 to sound an alarm audio file (i.e., sound the alarm again) after the system time reaches a preset time period.

In step S302, a detecting module 34 detects the input signal of an input unit 50 during the sounding of the alarm audio file.

In step S303, an analysis module 31 determines the operation type according to the input signal. In the embodiment, the operation type is a first operation, a second operation, or a third operation. The analysis module 31 determines that the operation type is the first operation if the input signal does not exists beyond a third preset time period T3. The analysis module 31 determines that the operation type is the second operation if the input signal exists beyond the third preset time period T3 but not beyond a fourth preset time period T4; the analysis module 31 determines that the operation type is the third operation if the input signal exists beyond the fourth preset time period T4.

In step S304, The alarm control module 33 executes an alarm command according to the operation type. In the embodiment, the alarm control module 33 controls the alarm speaker unit 50 to stop sounding the alarm, and to sound the alarm again after a first preset time period t1, if the operation type is the first operation type. The alarm control module 33 controls the alarm speaker unit 50 to sound the alarm again after a second preset time period t2, if the operation type is the second operation type. The alarm control module 33 controls the alarm speaker unit 50 to stop sounding the alarm if the operation type is the third operation type, until the alarm has been reset.

In another embodiment, the analysis module 31 identifies the operation type according to the number of operations or pressure of an operation applied to a control button in a preset time period.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device, comprising:
an input unit configured to generate input signals according to user inputs;
a storage unit configured to store audio files;
an alarm speaker unit configured to sound the audio files to execute an alarm command; and
a processing unit configured to read an audio file and control the alarm speaker unit to sound alarm after a time reaches a preset time, determine an operation type corresponding to the input signals and control the speaker unit to sound the alarm again after a preset time period, or never alarm again until the electronic device has been reset according to the operation type, wherein the processing unit controls the speaker unit to sound the alarm after a first preset time period if the operation type is a first type, or controls the speaker unit to sound the alarm after a second preset time period if the operation type is a second type, or control the speaker unit to never alarm again until it has been reset if the operation type is a third type.

2. The electronic device as described in claim 1, wherein the processing unit determines the operation type is the first type upon the condition that the input signal exists not beyond a third preset time period, determines the operation type is the second type upon the condition that the input signal exists beyond the third preset time period but not beyond a fourth preset time period, and determines the operation type is the third type upon the condition that the input signal exists beyond the fourth preset time period.

3. The electronic device as described in claim 1, wherein the processing unit determines the operation type according to the number of operations applied to the input unit in a preset time period.

4. The electronic device as described in claim 1, wherein the processing unit determines the operation type according to the pressure applied to the input unit.

5. The electronic device as described in claim 1, wherein the alarm audio file is randomly chosen by the processing unit.

6. The electronic device as described in claim 1, wherein the input unit is a touch panel or a control button.

7. The electronic device as described in claim 1, wherein the electronic device further comprises a display unit, the display unit displays the operation type and the time period to sound the alarm corresponding to the operation type.

8. An alarm method applied in an electronic device, comprising:
sounding an alarm after a time of the electronic device reaches a preset time;
receiving input signals from an input unit during the sounding of the alarm;
determining an operation type according to the input signals; and
resounding the alarm after a first preset time period upon the condition that the operation type is a first type, or resounding the alarm after a second preset time period upon the condition that the operation type is a second type, or never alarming again until the electronic device has been reset upon the condition that the operation type is a third type.

9. The method as described in claim 8, wherein determining the operation type is the first type upon the condition that the input signal exists not beyond a third preset time period, determining the operation type is the second type upon the condition that the input signal exists beyond the third preset time period but not beyond a fourth preset time period, determining the operation type is the third type upon the condition that the input signal exists beyond the fourth preset time period.

10. The method as described in claim 8, wherein the operation type is determined according to the number of operations applied to the input unit in a preset time period.

11. The method as described in claim 8, wherein the operation type is determined according to a pressure applied to the input unit.
